(19) United States
(12) Patent Application Publication
(10) Pub. No.: US 2015/0088652 A1
(43) Pub. Date: Mar. 26, 2015

(54) SYSTEMS AND METHODS FOR FACILITATING LOCATION-RELEVANT COMMUNICATION

(71) Applicant: NCR Corporation, Duluth, GA (US)

(72) Inventors: Michael Cain Finley, Roswell, GA (US); Andrew Smith, Atlanta, GA (US); Ben Mosher, Cumming, GA (US); Ed Brian Rieta, Cebu (PH); Jeffrey Daniel Hughes, Irving, TX (US)

(73) Assignee: NCR Corporation, Duluth, GA (US)

(21) Appl. No.: 14/038,477

(22) Filed: Sep. 26, 2013

(51) Int. Cl. G06Q 30/02

(52) U.S. Cl. CPC G06Q 30/0261
USPC 705/14.58

(57) ABSTRACT

Various methods are described for tracking the location of a customer possessing a mobile device and facilitating location-relevant communication between the mobile device and an establishment device. One example method may comprise detecting the presence of the customer within a first distance of an establishment. The method may further comprise receiving establishment information from the establishment entity for displaying to the customer to entice a visit to the establishment. Additionally, the method may comprise detecting the presence of the customer within a second distance of a location point within the establishment. Another example method may further comprise determining location information relevant to the location point; and providing for display of the location information to the customer. Similar and related methods, apparatuses, and computer program products are also provided.

### BACKGROUND OF THE INVENTION

The advancement of mobile technologies has broadened the capabilities of mobile devices, creating opportunities for new and advanced solutions to common problems. Establishments, such as retailers and restaurants, want consumers to have accurate, real-time information about their offerings. This information is most relevant when it is provided at a time and place that is conducive to a transaction with the consumer. However, many hurdles exist to determining when potential customers are in the relevant places and communicating with those customers when they are. Today's geolocation technologies have various shortcomings when attempting to quickly and accurately identify a customer's location. In particular, geolocation services often fail when attempting to locate a customer within a small margin of error of distance. Similarly, common geolocation techniques suffer when faced with interference of signals, such as in enclosed environments (e.g., when a customer is inside a store or restaurant). Even if geolocation services were able to identify a customer's location to a desired accuracy regardless of the customer's surroundings, retailers and restaurants do not have a sufficient means of communicating with the customer.

Accordingly, it may be desirable to provide systems, methods, apparatuses, and computer program products for facilitating location-relevant communication between a mobile device and an establishment device that avoid the above, and other, drawbacks associated with the current art.

### BRIEF SUMMARY OF THE INVENTION

Various embodiments of the present invention provide systems, methods, apparatuses, and computer program products for facilitating location-relevant communication between a mobile device and an establishment device. An example method for tracking the location of a customer possessing a mobile device may comprise detecting the presence of a customer within a first distance of an establishment; receiving establishment information from the establishment entity for displaying to the customer to entice a visit to the establishment; and detecting the presence of the customer within a second distance of a location point within the establishment.

An example mobile device for tracking the location of a customer possessing the mobile device may comprise at least one processor; and at least one memory comprising computer program code, the at least one memory and the computer program code configured to, with the at least one processor, cause the apparatus at least to: detect that a customer associated with the mobile device has entered a geofence associated with an establishment; provide for display of information associated with the establishment to the customer; and detect that the customer associated with the mobile device has entered a microfence associated with a location point of the establishment after the customer has entered the establishment.

Another example method for facilitating location-relevant communication between a mobile device of a customer and an establishment device may comprise detecting the presence of a customer within a microfence associated with a location point of the establishment; determining location information relevant to the location point; and providing for display of the location information to the customer.

The location point may be associated with a product, and the location information may comprise an offer associated with the product.

The location point may be associated with a point-of-sale terminal, and the location information may comprise an indication of the wait time for the point-of-sale terminal.

The establishment information may be selected from the group consisting of operating hours, inventory, pricing, offers, or promotions.

In an example embodiment, detecting the presence of the customer within the first and second distances may comprise the use of location services.

The location services for detecting the presence of the customer within the first distance may be selected from the group consisting of global positioning system (GPS), radio frequency identification (RFID), and Wi-Fi triangulation.

The location services for detecting the presence of the customer within the second distance may be selected from the group consisting of Bluetooth, Bluetooth Low Energy, Wi-Fi triangulation, and Near Field Communication (NFC).

The second distance may be proportionately smaller than the first distance.

The diameter of the geofence may be greater than one hundred feet, and wherein the diameter of the microfence may be less than fifty feet.

In another example embodiment, the mobile device may be further configured to establish a connection to a point-of-sale device associated with the establishment; and receive the information associated with the establishment from the point-of-sale device.

In an example embodiment, the mobile device may be further configured to receive the information associated with the establishment from the point-of-sale device via beacon stuffing.

In yet another example embodiment, the methods may further comprise tracking the position of the customer within the microfence; and determining an amount of time that the customer remains within the microfence.

### BRIEF DESCRIPTION OF THE DRAWINGS

Having thus described the invention in general terms, reference will now be made to the accompanying drawings, which are not necessarily drawn to scale, and wherein:

FIG. 1 provides an illustration of one embodiment of an architecture that can be used to practice various aspects of the present invention.

FIG. 2 provides a schematic diagram of a generic apparatus according to an embodiment of the present invention.

FIG. 3 provides a flowchart for facilitating location-relevant communication between a mobile device and an establishment device according to an embodiment of the present invention.

FIG. 4 provides a flowchart for tracking the location of a customer possessing a mobile device according to an embodiment of the present invention.

FIG. 5 provides a flowchart for facilitating location-relevant communication between a mobile device of a customer and an establishment device according to an embodiment of the present invention.

### DETAILED DESCRIPTION OF THE INVENTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. Like numbers refer to like elements throughout.

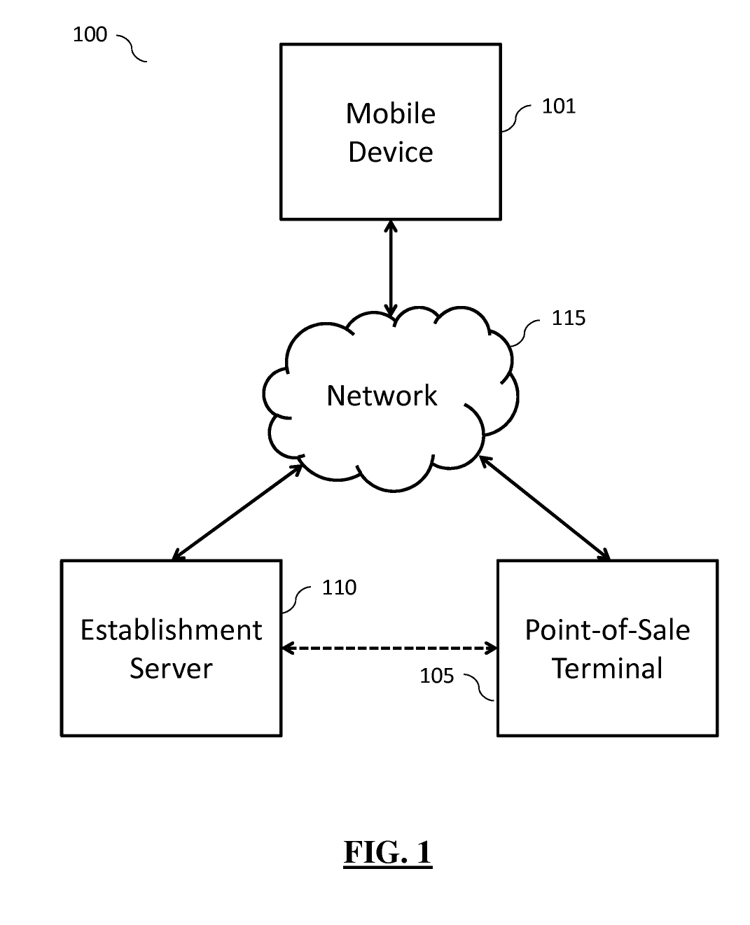

FIG. 1 provides an illustration of a system 100 that can be used in conjunction with various embodiments of the present invention to facilitate location-relevant communication between a mobile device and an establishment device. As shown in FIG. 1, the system 100 may include one or more mobile devices 101. For instance, a mobile device 101 may comprise a smartphone device, mobile telephone, mobile computer, portable digital assistant (PDA), laptop computer, gaming device, electronic tablet, or any other type of similar electronic device. The system 100 may further include one or more point-of-sale terminals 105. In some embodiments, the system 100 may also comprise one or more establishment servers 110. Each entity of the system 100 may be connected, directly or indirectly, to one or more other entities of the system 100 via a network 115. The network 115 may be a wired and/or wireless network comprising one or more of a local area network, wide area network, cellular network, internet, or the like. It should be noted that other system architectures are contemplated that may be used to practice various aspects of the invention. Thus, the system 100 provided in FIG. 1 is for illustrative purposes only and should not be construed to limit the scope of the invention. Further, while FIG. 1 illustrates certain system entities as separate, standalone entities, the various embodiments are not limited to this particular architecture.

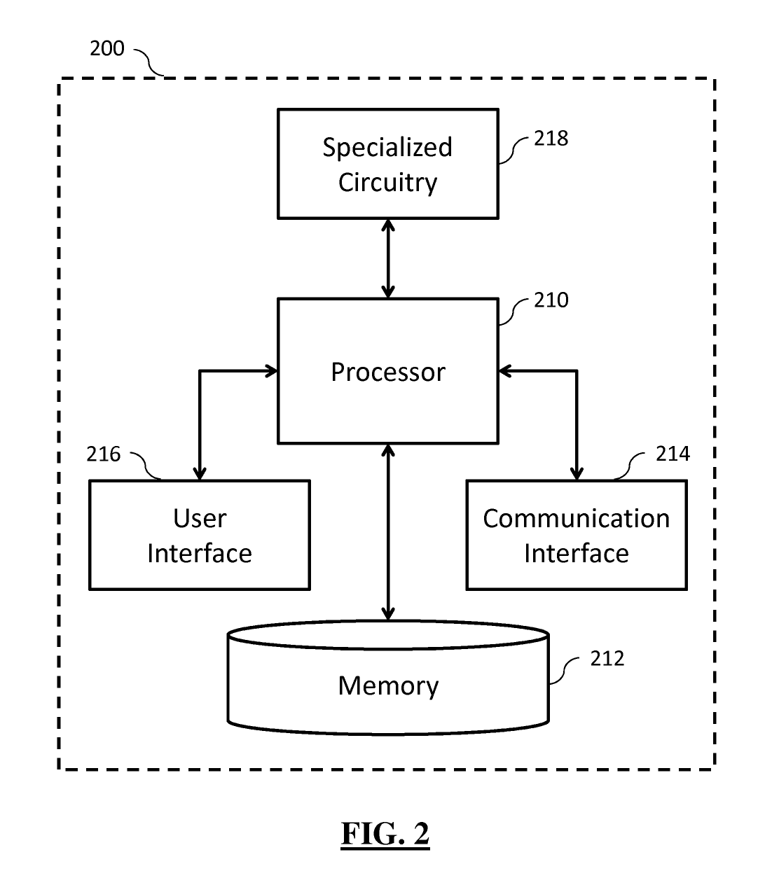

In various embodiments, a mobile device 101 and/or a point-of-sale terminal 105 may be embodied as or otherwise include an apparatus 200 as generically represented by the block diagram of FIG. 2. In the example embodiment, the apparatus 200 may comprise various means for performing the various functions herein described. These means may comprise one or more of a processor 210, memory 212, communication interface 214, user interface 216, or specialized circuitry 218. The various means may be in communication with one another, such as via a bus.

The means of the apparatus 200 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g., memory 212) that is executable by a suitably configured processing device (e.g., the processor 210), or some combination thereof. In some example embodiments, the processor 210, memory 212, communication interface 214, user interface 216, and/or specialized circuitry 218 may be embodied as a chip or chip set.

The processor 210 may, for example, be embodied as various means including circuitry, one or more microprocessors with accompanying digital signal processor(s), one or more processor(s) without an accompanying digital signal processor, one or more coprocessors, one or more multi-core processors, one or more controllers, one or more computers, various other processing elements including integrated circuits such as, for example, an ASIC (application specific integrated circuit) or FPGA (field programmable gate array), one or more other hardware processors, or some combination thereof. Although illustrated in FIG. 2 as a single processor, in some embodiments the processor 210 may comprise a plurality of processors. The plurality of processors may be in operative communication with each other and may be collectively configured to perform one or more functionalities of the apparatus 200 as described herein. The plurality of processors may be embodied on a single device or distributed across a plurality of devices collectively configured to function as the apparatus 200.

In some example embodiments, the processor 210 may be configured to execute instructions stored in the memory 212 or memory otherwise accessible to the processor 210. These instructions, when executed by the processor 210, may cause the apparatus 200 to perform one or more of the functionalities of the apparatus 200 as described herein. Further, the processor 210 may comprise functionality to operate one or more software programs, which may be stored in memory. For example, the processor 210 may be capable of operating a connectivity program, such as a web browser. The connectivity program may allow the apparatus 200 to transmit and receive web content, such as location-based content, according to a protocol, such as Wireless Application Protocol (WAP), hypertext transfer protocol (HTTP), and/or the like. The apparatus 200 may be capable of using protocol(s), such as Transmission Control Protocol/Internet Protocol (TCP/IP), to transmit and receive web content across the internet or other networks.

The memory 212 may comprise, for example, volatile memory, non-volatile memory, or some combination thereof. In this regard, the memory 212 may comprise one or more tangible and/or non-transitory computer-readable storage media that may include volatile and/or non-volatile memory. Although illustrated in FIG. 2 as a single memory, the memory 212 may comprise a plurality of memories. The plurality of memories may be embodied on a single device or may be distributed across a plurality of devices collectively configured to function as the apparatus 200. In various example embodiments, the memory 212 may comprise a magnetic storage device (e.g., hard disk), dynamic and/or static random access memory (RAM), read only memory (ROM), cache memory, flash memory, optical disc, subscriber identity module (SIM), removable user identity module (R-UIM), circuitry configured to store information, or some combination thereof. The memory 212 may be configured to store information, data, applications (e.g., software programs), instructions, and/or the like, in some instances for execution by the processor 210, for enabling the apparatus 200 to carry out various functions in accordance with various example embodiments.

The communication interface 214 may be embodied as any device or means embodied in circuitry, hardware, a computer program product comprising computer readable program instructions stored on a computer readable medium (for example, the memory 212) and executed by a processing device (for example, the processor 210), or a combination thereof that is configured to receive and/or transmit data from/to another computing device. The communication interface 214 may include, for example, an antenna, a transmitter, a receiver, a transceiver, and/or supporting hardware or software for enabling communications with one or more remote devices. The communication interface 214 may be configured to receive and/or transmit data using any protocol that may be used for communications between devices.

The user interface 216 may be in communication with the processor 210 to receive an indication of a user input and/or to provide an audible, visual, mechanical, or other output to a user. As such, the user interface 216 may include, for example, a keyboard, keypad, scanner, printer, mouse, joystick, display (e.g., touch screen display), microphone, speaker, and/or other input/output mechanisms. The processor 210 and/or user interface circuitry comprising the processor 210 may be configured to control one or more functions of the user interface 216 through computer program instructions (e.g., software and/or firmware) stored on memory (e.g., memory 212) accessible to the processor 210.

The specialized circuitry 218 may be embodied as various means, such as circuitry, hardware, a computer program product comprising computer readable program instructions stored on a computer readable medium (for example, the memory 212) and executed by a processing device (for example, the processor 210), or some combination thereof and, in some embodiments, is embodied as or otherwise controlled by the processor 210.

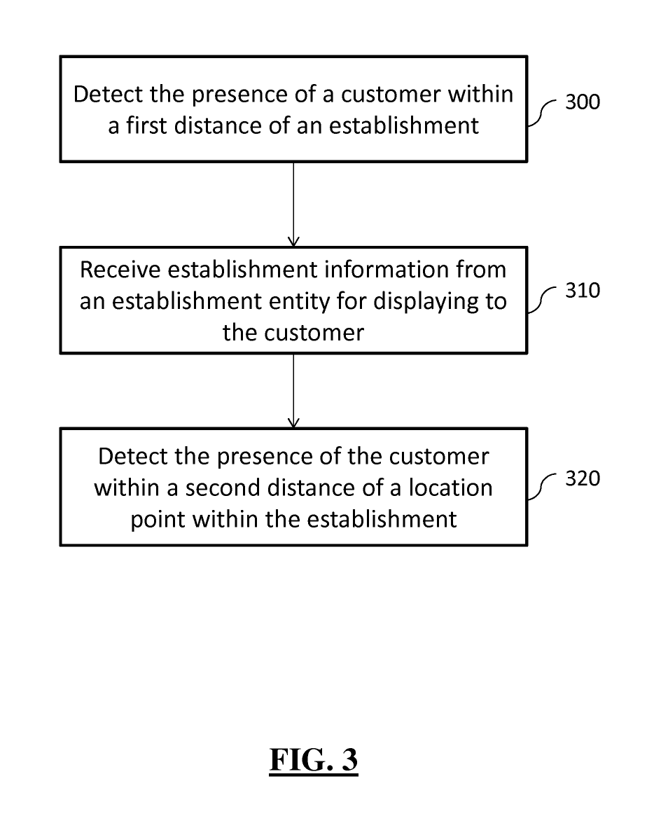

FIG. 3 provides a flowchart according to an example method for facilitating location-relevant communication between a mobile device and an establishment device. The operations performed by a method, apparatus, and computer program product of this example embodiment are illustrated from the perspective of an apparatus 200 embodied as a mobile device 101. The apparatus 200 embodied by the mobile device 101 may comprise means, such as the specialization circuitry 218, the processor 210, or the like. In this example embodiment, the various operations may be performed by the specialized circuitry 218 embodied as location-relevant communication circuitry.

According to various embodiments, a customer, or user, may own and possess a mobile device 101 configured to execute, via the specialized circuitry 218, one or more applications (e.g., mobile applications or apps). The customer may be in motion, or periodically in motion, with the mobile device 101, for example walking or driving along a street with various establishments.

Some applications on the mobile device 101 may be associated with a particular establishment (e.g., a store or restaurant) or group of establishments. Other applications may be associated with a company that provides a service associated with a number of establishments. For example, the company's application may provide a social service, such as a service for providing reviews for a number of third party establishments.

At operation 300, the mobile device 101 may be configured to detect that the customer is within a first distance of an establishment. For example, the mobile device 101 may detect that the customer has entered a geofenced area associated with the establishment. The detection may be accomplished using location services, including a combination of location services. The location services may comprise any geolocation or geofencing techniques. For example, the location services may rely on Global Positioning System (GPS), radio frequency identification (RFID), and/or the like.

In some instances, the customer, and therefore the mobile device 101, may not yet be inside the establishment at the instance of detection. For example, the customer may be passing by or near the store, but within range of the geofenced area. In other instances, the customer may have already entered the establishment.

After detecting the customer is within the first distance of the establishment, the mobile device 101 may provide information about the customer's location to an application on the mobile device 101 associated with the establishment (e.g., the customer's GPS location or an indication that the customer has entered a particular geofenced area). The application may send the location information, or an associated alert, to an entity (e.g., point-of-sale terminal 105) associated with the establishment. In other embodiments, the location information may be received by another service of the mobile device 101 or an application not provided by the establishment and sent by that service or application to the establishment entity.

In various embodiments, the mobile device 101 may establish a connection with the establishment entity, for example via a network (e.g., an establishment network), in some instances via one or more intervening entities (e.g., access points, servers). The connection may be established via the service or application on the mobile device 101. The connection may be used by the mobile device 101 to provide the location information described above to the establishment entity.

At operation 310, the mobile device 101 may be configured to receive establishment information from the establishment entity via the connection. For example, the mobile device 101 may receive information from the establishment entity to entice the customer to enter or remain in the establishment. The establishment information may include store hours, sales, promotions, specials, advertisements, product information, event information, and/or the like. The information may be personalized for the customer. For example, the information may describe special offers available to this particular customer and/or customized to meet the specific needs or interests of the customer.

According to example embodiments, the establishment information may include localized information. In some instances, the establishment information may include information specific to a single establishment, even in an instance in which the establishment is a part of a chain of establishments (e.g., a chain of restaurants). The localized establishment information may include operating hours, inventory, deals, prices, sales, offers, or promotions relevant to that establishment. In certain embodiments, the establishment information may only be temporarily relevant. For example, the establishment information may describe deals or offers only available for a limited time (e.g., a half hour, an hour, a day). In some examples, the duration of the offer may be such that it is sufficiently limited for the purpose of enticing the customer to enter the establishment and/or to make an immediate or rapid purchase.

In other instances, the mobile device 101 may alternatively, or in addition, receive information from one or more third party servers that may provide relevant information to a customer (e.g., social media, weather information, and/or the like). The third party information may be received over the same, or a different network, and in some instances may be routed through the establishment entity to the mobile device 101 over the connection.

In other embodiments, the mobile device 101 may receive broadcast establishment information prior to establishing a connection with an establishment entity. For example, an entity of the establishment (e.g., a point-of-sale terminal 105, access point, store server, or store computer) may broadcast information using techniques such as beacon stuffing. In some instances, the establishment entity broadcasting by beacon stuffing may not require a separate network connection itself.

In certain instances, the establishment entity may be configured to share its network connection, or create its own connection, with the mobile device 101. For example, a point-of-sale terminal 105 may be configured to allow tethering such that the mobile device 101 may establish a network connection via the point-of-sale terminal 105. In these embodiments, the mobile device 101 may not be connected to a network associated with the establishment.

At operation 320, the mobile device 101 may be configured to detect that the customer is within a second distance of a specific location point within the establishment. In this regard, the establishment may have one or more defined location points (e.g., a point-of-sale terminal 105, a queuing area, an entrance/exit) from which the customer's distance is measured. The second distance from the specific location point within the establishment may be proportionately smaller than the first distance from the establishment detected at operation 300. For example, the mobile device 101 may detect that the customer has entered a microfenced area associated with a location point within the establishment. In this regard, the term microfence may refer to an area similar to a geofenced area but proportionately smaller. In an example, the microfence may extend up to a given distance in all directions from the defined location point. In some instances, the second distance from the specific location point may be less than fifty feet, for example ten feet, one foot, or less.

In example embodiments, a microfence may extend geofences to include additional capabilities. For example, microfences may define smaller volumes than geofences, down to and including a single point of no volume but having a distance (e.g., from the mobile device 101 to the location point). In other examples, a microfence may define more irregular shapes than geofences. According to some embodiments, a microfence may include bi-directional communication between fencing hardware and mobile devices (e.g., mobile device 101). The microfence may track events such as approach, enter, exit, depart, and/or the like as well as dwell times in one or more of these stages. In some instances, a microfence may track disappear events when contact with a mobile device is lost.

The detection may be accomplished using location services, including a combination of location services. The location services may comprise any geolocation or geofencing techniques. For example, the location services may rely on Global Positioning System (GPS), radio frequency identification (RFID), and/or the like. In other embodiments, the location services may rely on localized standards and techniques, such as Bluetooth®, Bluetooth® Low Energy (BLE) (e.g., leashing), Wi-Fi (e.g., triangulation), Near Field Communication (NFC), and/or the like. These localized techniques may provide location services functionality in situations where other location services (e.g., GPS) would fail or are less reliable and less accurate, such as in enclosed environments (e.g., inside an establishment). In some instances, the accuracy of detection may increase as specific location points are approached.

In embodiments using BLE, and in some instances Wi-Fi, the mobile device 101 may use signal strength (e.g., received signal strength indication (RSSI)) to detect the location of the customer. For example, the signal strength may be mapped to a distance, for example using a calibration technique. In this regard, the signal strength of a particular signal may be mapped to a distance from the location point (e.g., a defined location point) where that signal originates. In some instances, the signal strength can be mapped to a coarse distance, such as to determine when a customer has entered an establishment. In other instances, the signal strength can be mapped to a fine distance, such as a customer's position in line of a checkout queue.

According to example embodiments, after detection at a location point, the mobile device 101 may be configured to communicate with an establishment entity (e.g., a point-of-sale terminal 105, store computer, store server). The communication may take place over the connection described above or over a separate connection established after detection. The connection may permit the exchange of information in either direction. That is, the mobile device 101 may send information to the establishment entity and/or the establishment entity may send information to the mobile device 101. Such communication may allow the mobile device 101 to interact with one or more entities or systems within the physical establishment, such as computing devices associated with the one or more location points.

In some embodiments, the mobile device 101 may send information about the customer to the establishment entity. For example, customer identification information (e.g., name, address, phone number, photo, loyalty information) may be sent by the mobile device 101 to the establishment entity. In this way, the establishment may be alerted to the customer's presence in the establishment or at a particular location point in the establishment. The customer identification information may permit the establishment to offer a greeting to the customer. For example, an employee of the establishment may locate and identify the customer using a photo provided by the mobile device 101 and greet the customer by name, again using information provided by the mobile device 101.

In various embodiments, the mobile device 101 may receive information about the establishment, or a particular location point, from an establishment entity. For example, the mobile device 101 may receive promotional information or deals from the establishment entity. In some instances, the mobile device 101 may receive location point specific information from the establishment entity. For example, if the location point is associated with a point-of-sale terminal 105 (e.g., a checkout register or self-service checkout station), the mobile device 101 may receive queue information related to that terminal, such as wait time. In another example, if the location point is associated with a product on display at the establishment (e.g., an item for sale), the mobile device 101 may receive an offer or special related to that product.

According to various embodiments, the mobile device 101 may be configured to monitor and track the position of the customer to the location point over time. In some instances, the mobile device 101 may begin tracking the customer after detection within a microfence and continue to track the customer while the customer remains within the microfence over time, which may be known as microfencing. For example, the mobile device 101 may track the customer's proximity to a point within the microfence, such as to a point-of-sale terminal 105.

In some embodiments, different actions may be associated with detecting the customer moving within different threshold distances established from a given point in the microfence. For example, when a consumer is only a very short distance from a point-of-sale terminal 105 (e.g., at the front of the queue) within the microfence, the mobile device 101 may receive transaction information of the customer to be used to perform payment.

The mobile device 101 may transmit the customer's position and/or proximity information to an establishment entity (e.g., a point-of-sale device 105, store computer, store server), in some instances via one or more intervening devices (e.g., access points, servers). The position and/or proximity information may be sent via an application on the mobile device 101, such as an application associated with the establishment.

According to example embodiments, the mobile device 101 and/or establishment entity (e.g., point-of-sale terminal 105) may be configured to collect, aggregate, and/or store position and/or proximity information of the customer to one or more of the location points. The mobile device 101 and/or establishment entity may be configured to maintain customer statistics from the position and/or proximity information received from one or more customers. The statistics may provide the establishment with information for operational improvements. For example, the establishment may measure average wait time that a customer endures, count customers who enter an establishment or microfence but do not make purchases, determine areas that are of most interest for consumers, and/or the like.

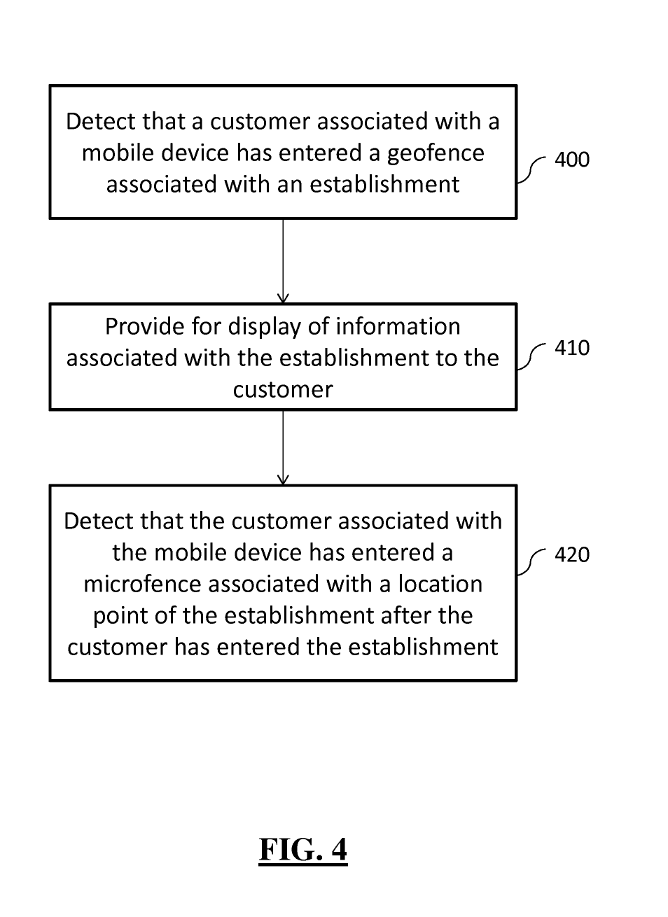

FIG. 4 provides a flowchart according to another example method for tracking the location of a customer possessing a mobile device. The operations performed by a method, apparatus (e.g., mobile device 101), and computer program product of this example embodiment are illustrated from the perspective of an apparatus 200 embodied as a mobile device 101. The apparatus 200 embodied by the mobile device 101 may comprise means, such as the specialization circuitry 218, the processor 210, or the like. In this example embodiment, the various operations may be performed by the specialized circuitry 218 embodied as mobile device tracking circuitry. The method, apparatus, and computer program product for tracking the location of a customer possessing a mobile device may comprise detecting that a customer associated with the mobile device has entered a geofence associated with an establishment at operation 400. At operation 410, the method, apparatus, and computer program product may comprise providing for display of information associated with the establishment to the customer. The method, apparatus, and computer program product may comprise detecting that the customer associated with the mobile device has entered a microfence associated with a location point of the establishment after the customer has entered the establishment at operation 420.

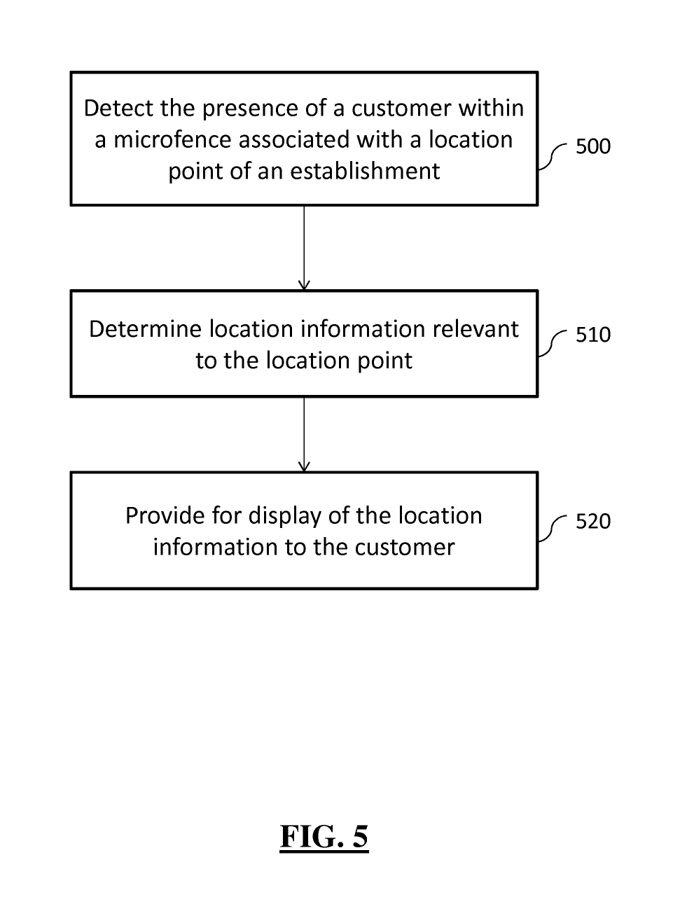

FIG. 5 provides a flowchart according to another example method for facilitating location-relevant communication between a mobile device of a customer and an establishment device. The operations performed by a method, apparatus (e.g., mobile device 101), and computer program product of this example embodiment are illustrated from the perspective of an apparatus 200 embodied as a mobile device 101. The apparatus 200 embodied by the mobile device 101 may comprise means, such as the specialization circuitry 218, the processor 210, or the like. In this example embodiment, the various operations may be performed by the specialized circuitry 218 embodied as location-relevant communication circuitry. The method, apparatus, and computer program product for facilitating location-relevant communication between a mobile device of a customer and an establishment device may comprise detecting the presence of the customer within a microfence associated with a location point of the establishment at operation 500. At operation 510, the method, apparatus, and computer program product may comprise determining location information relevant to the location point. The method, apparatus, and computer program product may comprise providing for display of the location information to the customer at operation 520.

FIGS. 3, 4, and 5 illustrate a flowchart of a system, method, and computer program product according to example embodiments of the invention. It will be understood that each block of the flowchart, and combinations of blocks in the flowchart, may be implemented by various means, such as hardware and/or a computer program product comprising one or more computer-readable mediums having one or more computer program code instructions, program instructions, or executable computer-readable program code instructions stored therein. For example, one or more of the procedures described herein may be embodied by computer program instructions of a computer program product. In this regard, the computer program product(s) that embodies the procedures described herein may be stored by one or more memory devices (e.g., memory 212) of an apparatus, server, or other computing device (e.g., apparatus 200) and executed by a processor (e.g., processor 210) in the computing device. In some embodiments, the computer program instructions comprising the computer program product(s) that embodies the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s).

Execution of instructions associated with the operations of the flowchart by a processor, or storage of instructions associated with the blocks or operations of the flowchart in a computer-readable storage medium, supports combinations of operations for performing the specified functions. It will also be understood that one or more operations of the flowchart, and combinations of blocks or operations in the flowchart, may be implemented by special purpose hardware-based computer systems and/or processors which perform the specified functions, or combinations of special purpose hardware and program code instructions.

The operations of the methods described herein may be carried out in any suitable order, or simultaneously where appropriate. The methods described herein may be performed by software in machine readable form on a tangible storage medium or as a propagating signal.

Numerous benefits may be realized from the implementation of embodiments of the present invention. Various advantageous embodiments provide the ability for customers to be made aware of retailer and restaurant offers that are specific to themselves at a time and place that is most relevant in their transaction process. In other advantageous embodiments, the retailer or restaurant may gather additional information about the customer's experience in their establishment, such as where the customer was and for how long during their transaction. Example advantageous embodiments permit a mobile device of a customer to first detect the customer's proximity to an establishment and to then detect the customer's proximity to various points of interest within the establishment once the customer enters. In various advantageous embodiments, the mobile device may take advantage of the characteristic decay of a radio signal over distance to allow for coarse tracking at longer distances but fine tracking at shorter distances, which helps provide inexpensive and sufficiently accurate values. Other advantageous embodiments take advantage of a combination of geolocation and microlocation strategies to overcome the impreciseness and unreliability of geolocation-only solutions. For example, the combination of geolocation and microlocation strategies provides successful solutions even in enclosed environments.

The terms “comprising”, “including”, “incorporating”, and “having” are used herein to recite an open-ended list of one or more elements or steps, not a closed list. When such terms are used, those elements or steps recited in the list are not exclusive of other elements or steps that may be added to the list.

Unless otherwise indicated by the context, the terms “a” and “an” are used herein to denote at least one of the elements, integers, steps, features, operations, or components mentioned thereafter, but do not exclude additional elements, integers, steps, features, operations, or components.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method for tracking the location of a customer possessing a mobile device comprising:
detecting the presence of the customer within a first distance of an establishment;
receiving establishment information from the establishment entity for displaying to the customer to entice a visit to the establishment; and
detecting the presence of the customer within a second distance of a location point within the establishment.

2. The method of claim 1, further comprising:
determining location information relevant to the location point; and
providing for display of the location information to the customer.

3. The method of claim 2, wherein the location point is associated with a product, and wherein the location information comprises an offer associated with the product.

4. The method of claim 2, wherein the location point is associated with a point-of-sale terminal, and wherein the location information comprises an indication of the wait time for the point-of-sale terminal.

5. The method of claim 1, wherein the establishment information is selected from the group consisting of operating hours, inventory, pricing, offers, or promotions.

6. The method of claim 1, wherein detecting the presence of the customer within the first and second distances comprises the use of location services.

7. The method of claim 6, wherein the location services for detecting the presence of the customer within the first distance are selected from the group consisting of global positioning system (GPS), radio frequency identification (RFID), and Wi-Fi triangulation.

8. The method of claim 6, wherein the location services for detecting the presence of the customer within the second distance are selected from the group consisting of Bluetooth, Bluetooth Low Energy, Wi-Fi triangulation, and Near Field Communication (NFC).

9. The method of claim 1, wherein the second distance is proportionately smaller than the first distance.

10. A mobile device for tracking the location of a customer possessing the mobile device comprising:
at least one processor; and
at least one memory comprising computer program code, the at least one memory and the computer program code configured to, with the at least one processor, cause the apparatus at least to:
detect that a customer associated with the mobile device has entered a geofence associated with an establishment;
provide for display of information associated with the establishment to the customer; and
detect that the customer associated with the mobile device has entered a microfence associated with a location point of the establishment after the customer has entered the establishment.

11. The mobile device of claim 10, wherein the information associated with the establishment is selected from the group consisting of operating hours, inventory, pricing, offers, or promotions.

12. The mobile device of claim 10, wherein the at least one memory and the computer program code are further configured to, with the at least one processor, cause the mobile device to:
determine location information relevant to the location point; and
provide for display of the location information to the customer.

13. The mobile device of claim 10, wherein the at least one memory and the computer program code are further configured to, with the at least one processor, cause the mobile device to:
establish a connection to a point-of-sale device associated with the establishment; and
receive the information associated with the establishment from the point-of-sale device.

14. The mobile device of claim 10, wherein detecting the presence of the customer within the first and second distances comprises the use of location services.

15. The mobile device of claim 14, wherein the location services for detecting that the customer associated with the mobile device has entered a microfence are selected from the group consisting of Bluetooth, Bluetooth Low Energy, Wi-Fi triangulation, and Near Field Communication (NFC).

16. The mobile device of claim 15, wherein the diameter of the geofence is greater than one hundred feet, and wherein the diameter of the microfence is less than fifty feet.

17. A method for facilitating location-relevant communication between a mobile device of a customer and an establishment device comprising:
detecting the presence of the customer within a microfence associated with a location point of the establishment;
determining location information relevant to the location point; and
providing for display of the location information to the customer.

18. The method of claim 17, wherein the location point is associated with a product, and wherein the location information comprises an offer associated with the product.

19. The method of claim 17, wherein the location point is associated with a point-of-sale terminal, and wherein the location information comprises an indication of the wait time for the point-of-sale terminal.

20. The method of claim 17, wherein detecting the presence of the customer within the microfence comprises the use of location services.

21. The method of claim 20, wherein the location services for detecting the presence of the customer within the microfence are selected from the group consisting of Bluetooth, Bluetooth Low Energy, Wi-Fi triangulation, and Near Field Communication (NFC).

22. The method of claim 21, further comprising:
tracking the position of the customer within the microfence; and
determining an amount of time that the customer remains within the microfence.
